(19) United States
(12) Patent Application Publication
(10) Pub. No.: US 2007/0028005 A1
(43) Pub. Date: Feb. 1, 2007

(54) Communication system with integrated services and adapting and connection device for an environment having several spatial zones

(75) Inventors: Nobert Grund, Mainz (DE); Thomas Gommermann, Floersheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Deutsche Telekom AG, Bonn (DE)

(21) Appl. No.: 10/565,419

(22) PCT Filed: Jun. 4, 2004
(86) PCT No.: PCT/DE04/01159

§ 371 Date: Jan. 23, 2006

(30) Foreign Application Priority Data
Jul. 24, 2003 (DE) 103 33 608.7

(51) Int. Cl. G06F 15/16

(52) U.S. Cl. 709/249

(57) ABSTRACT

A communication system for integrating services in an environment having a plurality of spatial zones, the communications system includes an IP-based communication network and at least one adapting and connecting device connected to the IP-based communication network and assigned to one of the plurality of spatial zones. The adapting and connecting device has an IP address, a first group of first interfaces configured to connect to non-IP-based devices, and a converting device. The converting device is configured to convert a message being supplied to or being supplied by at least one of the IP-based devices into IP data in accordance with an IP protocol.

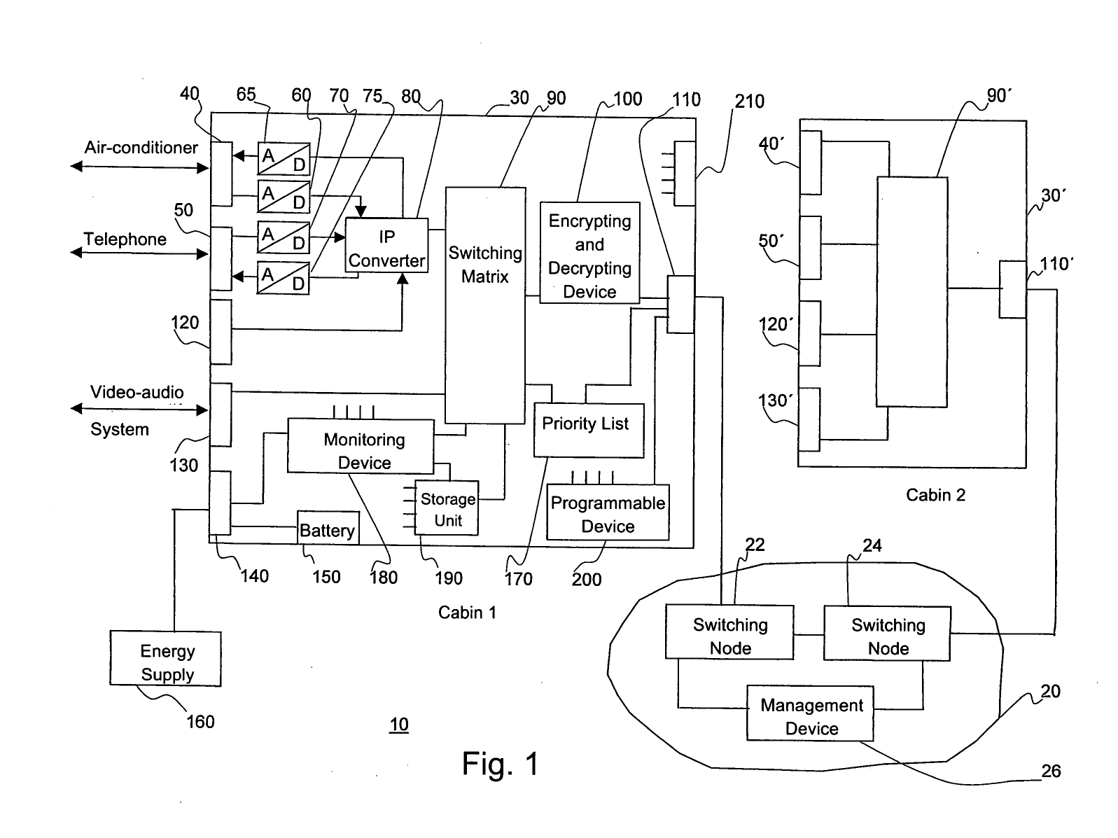

The invention relates to a communication system for integrating services in an environment having several spatial zones, particularly in a ship having several cabins. Furthermore, the invention relates to an adapting and connecting device for use in such a communication system for integrating services.

Up until now, it has been common practice to install and maintain separate networks on board ships for different services such as, for instance, telephone, climate control, video and audio systems or video surveillance. Consequently, the provision of new services as well as the connection of more on-board cabins to existing networks always entails considerable effort and work.

Therefore, the invention is based on the objective of providing a communication system for integrating services as well as an adapting and connecting device in an environment having several spatial zones, which should simplify the provision of new services and the implementation of services in spatial zones that have been added. These spatial zones can be cabins on a ship, hotel rooms and the like.

A core idea of the invention lies in defining a standardized interchange point via which different devices containing electronic components such as telephones, heaters, lamps, television sets and audio equipment as well as different systems such as, for example, telephone systems, audio and video systems, air-conditioners as well as surveillance systems of all types can be connected by means of an IP-based communication network.

The above-mentioned objective is achieved, on the one hand, by means of a communication system for integrating services according to claim 1.

According to this claim, the communication system for integrating services comprises an IP-based (IP=Internet protocol) communication network that can be a hard-wired network on the basis of, for example, copper lines or fiberglass, or else a wireless network. At least one adapting and connecting device is connected to the IP-based communication network, whereby the adapting and connecting device is assigned to a spatial zone, for instance, a ship cabin. The adapting and connecting device has a first group of interfaces for connecting non-IP-based devices as well as a conversion device for converting messages supplied by a non-IP-based device into IP data in accordance with an IP communication protocol. The non-IP-based devices can be air-conditioners, individual radiators, telephone systems, individual telephones, monitoring devices, for example, in the form of fire detectors and the like. Each adapting and connecting device connected to the IP-based communication network is assigned its own IP address.

Advantageous refinements are the subject matter of the subordinate claims.

A second group of interfaces is provided in order to be able to connect IP-based devices to the adapting and connecting device as well. The IP-based devices are, for instance, computers and video or audio systems.

In an advantageous manner, a pre-specified priority is assigned to at least some of the interfaces and the adapting and connecting device has a priority-controlled switching matrix for connecting an interface to the IP-based communication network.

Since the data provided by the IP-based devices as well as by the non-IP-based devices can contain more or less important information, it is practical to assign a pre-specified priority to at least one message intended for at least one interface, whereby the adapting and connecting device has a priority-controlled switching matrix for forwarding the message in accordance with its priority to the IP-based communication network.

For example, the message with the highest priority is the first to be forwarded. In order not to lose messages having a lower priority, these messages can be temporarily stored in a storage unit so that they can be forwarded at a later point in time.

If one of the interfaces is an analog interface, then an analog-to-digital and digital-to-analog converter is assigned to this interface so that the data coming from the interface as well as the data forwarded to the interface via the IP-based communication network can be appropriately converted.

In order to provide users with customer-specific authorizations or with authorizations for certain services as a function of the spatial zones, the adapting and connecting device is provided with a programmable device for activating and deactivating the interfaces.

If, for instance, a customer is not given authorization for making phone calls, then only the interface assigned to the telephone or to the telephone system has to be deactivated.

Advantageously, the adapting and connecting device can be configured and maintained remotely. However, it is likewise conceivable for the configuration to be done via a computer that can be externally connected to the adapting and connecting device.

The configuration data can be stored in an internal storage unit. In order to be able to temporarily store the data coming from the IP-based devices as well as from the non-IP-based devices, an appropriate storage unit is provided in the adapting and connecting device. In this manner, message segments can be stored temporarily until a complete message that is to be forwarded has been received.

In order to ensure the functionality of the interfaces, a monitoring device as well as a device for generating and transmitting status and/or error messages to a management device are provided. In order to also be able to receive and send confidential data, the adapting and connecting device is provided with a device for encrypting and decrypting messages.

Advantageously, the adapting and connecting device is supplied with power by means of an external supply network, for example, the electrical system of the ship. In addition, a battery can be provided that is charged via the power supply system of the ship. These sources of energy can supply power to the adapting and connecting device as well as to the IP-based devices and the non-IP-based devices optionally connected thereto.

The above-mentioned objective is likewise achieved by an adapting and connecting device according to claim 11. The adapting and connecting device has a first group of interfaces for connecting non-IP-based devices as well as a conversion device that converts messages supplied by a non-IP-based device into IP data in accordance with an IP communication protocol.

The above-mentioned devices can be hardware components and/or software components.

Advantageous embodiments are the subject matter of the subordinate claims.

The invention will be explained in greater detail below on the basis of an embodiment in conjunction with an accompanying drawing.

The FIGURE shows a communication system for integrating services designated with the reference numeral 10 which can be implemented, for example, in a ship and by means of which systems and devices arranged in various cabins of the ship can be connected. The FIGURE shows an IP-based communication network designated with the reference numeral 20 which, for the sake of simplicity, only has two switching nodes 22 and 24 as well as a management device 26 that monitors and manages the communication system for integrating services. An adapting and connecting device 30, hereinafter also referred to as a cabin-service and application gateway, also gateway for short, is connected to the switching node 22. This gateway 30 is implemented in a cabin 1 of the ship and it serves to adapt different systems and devices such as, for example, air-conditioners, radiators, telephone systems, telephones, computers or video and audio systems, to a homogeneous IP-based communication platform. In the example at hand here, the gateway 30 has two analog interfaces 40 and 50 that are connected via an analog-to-digital converter 60 and a digital-to-analog converter 65 or via an analog-to-digital converter 70 and a digital-to-analog converter 75 and a so-called IP converter 80 to a priority-controlled switching matrix 90. The task of the IP converter 80 is to convert the data coming from the analog-to-digital converters 60 and 70 into IP data, preferably IP-data packages according to an IP-based communication protocol, since only such data can be transmitted via the IP-based communication network 20. Conversely, the IP converter 80 ensures that the data arriving in an IP format via the IP-based communication network 20 in conjunction with the appertaining digital-to-analog converters 65, 75 is converted into data that can be processed by the systems or devices connected to the analog interfaces 40 and 50. The priority-controlled switching matrix 90 is connected, for instance, via an encrypting and decrypting device 100, to a connection device 110 via which the gateway 30 is connected to the switching nodes of the IP-based communication network 20. Furthermore, the gateway 30 has, for example, two additional interfaces 120 and 130, said interface 130 serving to connect IP-based systems or devices such as, for instance, video and audio systems or computers. Consequently, the interface 130 can be connected to the priority-controlled switching matrix 90 without using the IP converter 80. The interface 120 serves to connect digital, non-IP-based systems or devices. Consequently, the interface 120 is connected via the IP converter 80 to the priority-controlled switching matrix 90. The electrical system 160 of the ship supplies energy to the gateway 30 and optionally to the devices and systems connected to the interfaces 40, 50, 120 and 130. The energy is fed in at a network connection designated with the reference numeral 140. An internal battery 150 that can be charged by the electrical system 160 of the ship is provided in order to ensure the functionality of the gateway 30 and optionally of the devices and systems connected thereto.

Since the data coming from the devices connected to the interfaces 40, 50, 120 and 130 can be of differing degrees of importance and relevance, each interface or the services that are handled through it (for example, telephone, video and audio services) can be assigned a certain priority. The priority assigned to a given interface is stored in a priority list storage unit 170. If messages are present simultaneously at several interfaces, or if several messages are present for at least one interface, then, on the basis of the priority list stored in the priority list storage unit 170, the priority-controlled switching matrix 90 decides which interface or which message is to be connected to the connection device 110 as a function of the assigned priority. For instance, the interface with the highest priority is connected to the connection device 110. The messages arriving at the other interfaces can be temporarily stored in a storage unit 190 according to their specific priority and then transmitted to the connection device 110 at a later point in time as a function of their priority. The same procedure takes place when messages are transmitted via the connection device 110 to the appertaining interfaces and to the terminal devices connected thereto. A monitoring device 180 is connected to the interfaces 40, 50, 120, 130 as well as to the network connection 140 in order to monitor the status and the functionality of these devices. The monitoring device 180 is also designed to generate status and/or error signals. In order to transmit status and/or error messages, the monitoring device 180 is connected to the priority-controlled switching matrix 90. The gateway 30 can be implemented in such a way that the status and/or error messages generated by the monitoring device 180 are automatically transmitted to the management device 26. This data can be transmitted in encrypted form. The status and/or error messages generated by the monitoring device 180 can be logged in the storage unit 190 or in another storage unit not shown here. The messages or partial messages present at the interfaces 40, 50, 120, 130 can be stored in this storage unit or in another storage unit not shown here. In this manner, incoming partial messages can be stored temporarily until a complete message to be forwarded via the IP-based communication network 20 has been received. In a similar manner, messages or partial messages received via the IP-based communication network 20 can be stored temporarily in this storage unit. Temporary storage of messages received via the IP-based communication network 20 is also expedient if one of the interfaces or the systems or devices connected thereto are defective. In this manner, messages are not lost and they can be forwarded as soon as the interface or the device connected thereto is once again operational. For the sake of simplicity, the FIGURE shows only two cabins. A gateway 30′ that is connected via a connection unit 110′ to the switching node 24 of the IP-based communication network 20 is likewise implemented in the cabin 2. The gateway 30′ is only depicted schematically since its structure can match the structure of the gateway 30.

The gateways 30 and 30′ can be configured, for instance, by means of the management device 26. It is likewise conceivable to program the gateway functionality on site using a computer that can be connected externally to any gateway. For example, an interface 210 is implemented in the gateway 30 so that such a computer can be connected.

According to an advantageous implementation, the IP addresses are assigned to the gateways by means of the management device 26. The management device 26 can in turn, address the interfaces 40, 50, 120, 130 and optionally the devices connected to the appertaining interfaces.

Moreover, a programmable device 200 is provided, for instance, for activating and deactivating the interfaces 40, 50, 120, 130.

Even though the IP-based communication network 20 is depicted as a local network, the IP-based communication network 20 has network transition devices by means of which the gateway 30 or 30′ can be connected to external communication networks such as, for instance, the Internet, a cellular network and/or a public telephone network. For the sake of simplicity, these network transitions are not shown.

1-19. (canceled)

20. A communication system for integrating services in an environment having a plurality of spatial zones, the communications system comprising:
an IP-based communication network; and
at least one adapting and connecting device connected to the IP-based communication network and assigned to one of the plurality of spatial zones, the adapting and connecting device having an IP address, a first group of first interfaces configured to connect to non-IP-based devices, and a converting device, wherein the converting device is configured to convert a message being supplied to or being supplied by at least one of the IP-based devices into IP data in accordance with an IP protocol.

21. The communications system as recited in claim 20, wherein the environment is on a ship and the spatial zones include zones of the ship.

22. The communication system as recited in claim 20, further comprising a second group of second interfaces configured to connect to IP-based devices.

23. The communication system as recited in claim 20, wherein at least one of the first and second interfaces includes an assigned pre-specified priority and wherein the adapting and connecting device has a priority-controlled switching matrix for connecting the at least one of the first and second interfaces to the IP-based communication network.

24. The communication system as recited in claim 20, wherein the message includes an assigned pre-specified priority and the adapting and connecting device has a priority-controlled switching matrix configured to forward the message to the IP-based communication network in accordance with the pre-specified priority.

25. The communication system as recited in claim 20, wherein the adapting and connecting device includes an analog-to-digital and a digital-to-analog converter, each being assigned to one of the first interfaces.

26. The communication system as recited in claim 20, wherein the adapting and connecting device has a programmable device configured to activate or deactivate at least one of the first and second interfaces.

27. The communication system as recited in claim 20, wherein the adapting and connecting device is capable of being configured and maintained remotely.

28. The communication system as recited in claim 20, wherein the adapting and connecting device includes a storage unit, the storage unit configured to store at least one of configuration data, messages received at the first and second interfaces, and messages received over the IP-based communications network.

29. The communication system as recited in claim 20, wherein the IP-based communications network includes a management device, and wherein the adapting and connecting device has a monitoring device connected to at least one of the first and second interfaces and configured to generate and transmit at least one of a status and an error message to the management device.

30. The communication system as recited in claim 20, wherein the adapting and connecting device has an encryption device configured to encrypt and decrypt messages.

31. The communication system as recited in claim 20, wherein the adapting and connecting device has an internal power supply device configured to temporarily supply the IP-based devices and the non-IP-based devices connected to the first and second interfaces with electric power.

32. An adapting and connecting device comprising:
a first group of first interfaces configured to connect to non-IP-based devices; and
a converting device, wherein the converting device is configured to convert a message being supplied to or being supplied by at least one of the IP-based devices into IP data in accordance with an IP protocol.

33. The adapting and connecting device as recited in claim 32, further comprising a second group of second interfaces for connecting IP-based devices.

34. The adapting and connecting device as recited in claim 32, wherein at least one of the first and second interfaces has an assigned pre-specified priority, and further comprising a priority-controlled switching matrix configured to connect that at least one interface to an IP-based communication network.

35. The adapting and connecting device as recited in claim 32, wherein at least one message intended for at least one of the first and second interfaces has an assigned pre-specified priority, and further comprising a priority-controlled switching matrix configured to forward the at least one message to an IP-based communication network.

36. The adapting and connecting device as recited in claim 32, further comprising a programmable device configured to activate or deactivate at least one of the first and second interfaces.

37. The adapting and connecting device as recited in claim 32, further comprising a monitoring device configured to generate and transmit at least one of a status and an error message to a management device.

38. The adapting and connecting device as recited in claim 32, further comprising an encryption device configured to at least one of encrypt and decrypt a message.

39. The adapting and connecting device as recited in claim 32, further comprising an internal power supply device.
